(19) United States
(12) Patent Application Publication
(10) Pub. No.: US 2006/0039375 A1
(43) Pub. Date: Feb. 23, 2006

(54) Method, communication system and communication device for trainsmitting broadcasting information via a communication network

(76) Inventor: Thomas Bahls, Greifswald (DE)

Correspondence Address: Siemens Corporation;Intellectual Property Department, 170 Wood Avenue South, Iselin, NJ, 08830, US

(21) Appl. No.: 10/522,834

(22) PCT Filed: Jul. 8, 2003
(86) PCT No.: PCT/DE03/02280

§ 371 Date: Aug. 23, 2005

(30) Foreign Application Priority Data
Jul. 31, 2002 (DE) 102349398

(51) Int. Cl. H04L 12/56

(52) U.S. Cl. 370/390

(57) ABSTRACT

According to the invention, in order to transmit information which is specific to a subscriber connection, apart from virtual connections which are specific to a subscriber connection, at least one other virtual connection is established between a central communication unit and at least one decentralised communication unit by means of at least one communication network. Broadcasting information which is sent to the central communication unit is analysed in order to determine whether at least part of the broadcasting information is to be transmitted to a plurality of subscriber connections of the at least one decentralised communication unit. The at least part of the broadcasting information for a plurality of subscriber connections is transmitted by means of the at least one other virtual connection to the at least one decentralised communication unit where it is copied and transmitted to the plurality of subscriber connections.

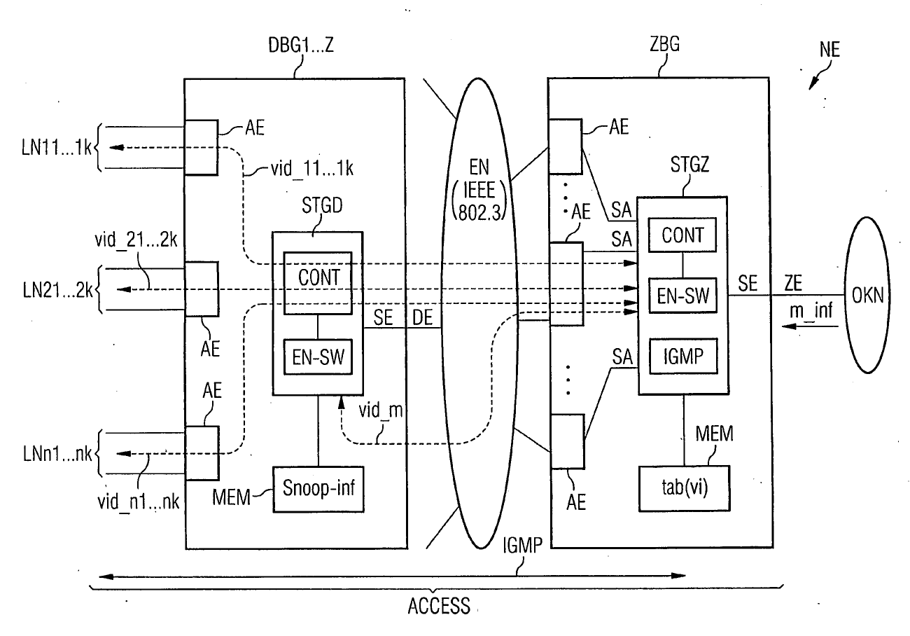

### CROSS REFERENCE TO RELATED APPLICATIONS

This application is the US National Stage of International Application No. PCT/DE03/02280, filed Jul. 8, 2003 and claims the benefit thereof. The International Application claims the benefits of German application No. 10234939.8 DE filed Jul. 31, 2002, both of the applications are incorporated by reference herein in their entirety.

### FIELD OF INVENTION

This invention relates to a method, communication system and communication device for transmitting broadcasting information via a communication network.

### BACKGROUND OF INVENTION

In current access networks the subscriber access connection designed in accordance with an xDSL data transmission method and providing high transmission rates is typically in increasingly widespread use. The broadband Internet access which this makes possible for example is constantly expanding the number of uses or applications provided by these access networks. One of these applications is the transmission of information with multimedia content—also referred to as broadband data streams—such as videos or video streams. Broadband distribution services, especially multimedia distribution services (e.g. radio and television) as well as on-demand services such as “Video-On-Demand” or broadband Internet communication (e.g. video conferences) can be implemented with the aid of these applications. “Multicast” or “Multicasting” is increasingly being used to transmit broadband data streams via communication networks.

Multicast or multicasting describes the capability of a communication network or of the services realized within it to establish connections to a number of connected subscribers or to send information or messages to a number of previously defined subscribers (recipients). Within the framework of multicast or multicasting there is the option of addressing a number of subscribers via just one address (multicast, group address).

In the case of frame or packet-oriented communication networks multicasting makes it possible to handle the transmission resources made available by the communication network more efficiently and, with the appropriately powerful network components or network nodes, to transmit the information to be distributed—also referred to below as broadcasting information—just once from the source towards the subscribers. The network nodes involved in information transmission then independently analyze the incoming data packets and only copy the data at the necessary distribution points to forward it on a number of different connections, so that the data stream only branches at the latest possible points, i.e. close to the subscribers. Within the context of distribution services for example the aim is for n customers, e.g. those requesting or subscribing to the same video stream, to occupy less than n times the bandwidth in the communication network. This is done by transmission of the simple data stream for as long as the network sections needed are identical for a plurality of recipients. Only at the point at which the data is branched out on different transmission links or on different virtual connections is it duplicated or replicated. This type of branching point is represented for example by a remote communication device located locally in a communication network—e.g. a multiplexer, DSLAM—to which the relevant assigned subscribers or subscriber connections are connected via a virtual connection for a specific subscriber connection of an access network in each case and the information for the individual subscribers is transmitted between the subscribers and the communication unit via the virtual connections that have been set up. Normally on the network side the multicast protocol used within the framework of multicasting is terminated in this communication device, i.e. a multicast data stream arriving at this communication device or at least a part of the stream is replicated n times and the replicated data streams are transmitted over the virtual connections specific to individual subscribers in the direction of the subscribers.

This n-times transmission of broadband data streams, especially as a result of the distribution services implemented in subscriber access networks, represents an ineffective use or a waste of the transmission resources provided by the access networks.

### SUMMARY OF INVENTION

The underlying object of the invention is thus to improve the implementation of distribution services and in particular to achieve a more efficient utilization of the transmission resources made available by the access networks for broadcasting information transmitted within the framework of a “multicast”. The object is achieved in accordance with the features of the claims.

With the method in accordance with the invention broadcasting information routed to a central communication unit is transmitted to subscriber connections connected to at least one decentralized communication unit via at least one communication network. For the transmission of the information to individual subscriber connections, starting from the central communication unit, at least one virtual connection specific to the individual subscriber connection is set up via the communication network, via the decentralized communication unit to/via each subscriber connection in each case. The important aspect of the method in accordance with the invention is that at least one further virtual connection is set up in each case between the central unit and the at least one decentralized communication unit. In the central communication unit the broadcasting information is checked as to whether at least a part of the broadcasting information is to be transmitted to a number of subscriber connections of the at least one decentralized communication unit. The at least one part of the broadcasting information for a number of subscriber connections is transmitted via the at least one further virtual connection to the at least one decentralized communication unit, duplicated in this unit and forwarded in each case to/via the number of subscriber connections.

The main advantage of the method in accordance with the invention lies in the fact that the branching point or replication point needed, at which at least a part of the transmitted multicast data stream or the transmitted broadcasting information is to be replicated, are shifted further towards the subscribers. This avoids an n-times transmission of broadband data streams or broadcasting Information via the same communication network so that precious transmission resources can be saved or the transmission resources provided can be used efficiently. Advantageously the replication of the broadcasting information does not have to be undertaken as per the prior art at one of the network side end points of the virtual connection for the specific subscriber connection usually arranged in a central communication unit; Instead the information to be transmitted, provided the physical transmission link is identical, is transmitted just once in parallel to the virtual connections specific to the subscribers, via at least one further virtual connection specifically provided for this purpose, to a decentralized communication unit. The decentralized communication unit is the end point of this at least one specific virtual connection—also referred to below as a virtual connection specific to the communication unit—which is not assigned to any subscriber. The broadcasting information transmitted via this specific virtual connection is thus identified as broadcasting information to be replicated, so that expensive monitoring of the information arriving at the decentralized communication unit can be dispensed with.

In accordance with an advantageous further development of the method in accordance with the invention different transmission protocols are implemented by the virtual connections for specific subscriber connections routed via the at least one decentralized communication unit. For each of the transmission protocols implemented via the at least one decentralized communication unit at least one further virtual connection between the central unit and the at least one decentralized communication unit is set up for the individual transmission protocol. Advantageously the broadcasting information routed to the central communication unit is checked to see if this information is to be transmitted to a number of subscriber connections of the at least one decentralized communication unit implementing the same transmission protocol. If it is established that at least a part of the broadcasting information is to be transferred to a number of subscriber connections implementing the same protocol the at least one part of the broadcasting information is transmitted from the central communication unit via the at least one individual virtual connection for the transmission protocol to the at least one decentralized communication unit, duplicated there and forwarded to/via the number of subscriber connections implementing the same transmission protocol. This advantageous further development of the method in accordance with the invention enables the subscribers assigned to a decentralized module to be connected by means of different data transmission methods, that is using differently designed protocol stacks. For each type of protocol stack implemented in the decentralized communication unit or for each type of data transmission method implemented an individual virtual connection i.e. a virtual connection individual to a communication unit and simultaneously to protocol stack is set up for transmitting the broadcasting information between the at least one decentralized module and the central module. Thus the method in accordance with the invention can also be used if subscriber connections providing different transmission technologies or virtual connections designed in accordance with different transmission protocols are arranged in a decentralized communication unit or decentralized module.

Further advantageous embodiments of the method in accordance with the invention as well as a communication system and a communication device for performing the method can be found in the dependent claims.

### BRIEF DESCRIPTION OF THE DRAWING

The method in accordance with the invention is explained in greater detail below with reference to a drawing in the form of a block diagram.

### DETAILED DESCRIPTION OF INVENTION

The block diagram shows the structure of a network element NE arranged in a subscriber access network ACCESS—for example of a remote Digital Subscriber Line Access multiplexer (DSLAM). The network element NE comprises a central communication unit ZBG designed as a module and a number of decentralized communication units DBG1_z also designed as modules, with the block diagram only showing one decentralized communication unit to represent a number of said units. A control unit STGZ is arranged in the central communication unit or central module ZBG which comprises control means CONT to execute the method in accordance with the invention as well as an Ethernet Switch EN-SW designed in accordance with IEEE-Standard 802.3. Means IGMP for network termination of the IGMP protocol are also provided in the control unit STGZ. The IGMP protocol is for example described in the document IGMP V2,RFC2236.

The control unit STGZ is connected via an input SE as well as via a further input ZE assigned to the central module ZBG to a higher-level communication network OKN. The control unit STG is connected via one output SA in each case to an access unit AE arranged in the central module ZBG. The central module ZBG is connected via one of the access units AE in each case to a communication network EN—referred to hereafter as the Ethernet—designed in accordance with IEEE-Standard 802.3 and provided as internal wiring of the modules (backplane). The central communication unit ZBG is connected via the internal communication network or Ethernet EN to an input DE of the individual decentralized modules DBG1_z. The decentralized modules DBG1_z each feature a control unit STGD which also includes control means CONT for executing the method in accordance with the invention as well as an Ethernet Switch EN-SW designed in accordance with IEEE Standard 802.3. The control unit STGD is connected via an input SE to the input DE of the relevant decentralized modules DBG1_z. Furthermore the control unit STGD is connected via an output SA to corresponding subscriber access units AE arranged in the decentralized modules DBG1_z. A number of subscribers are connected to these subscriber access units AE via trunks or subscriber connections TLN11_nk in each case. The relevant subscribers TLN11_nk can be connected to the individual subscriber access units AE of the decentralized modules DBG1_z for example by means of twin copper wires over which an xDSL transmission method is implemented in each case.

It is assumed below that a multicast data stream comprising broadcasting information m_inf is transmitted via the higher-level communication network OKN to the input SE of the central module ZBG terminating the multicast protocol. The multicast data stream is for example designed in accordance with the Internet Protocol, with the transmitted broadcasting information m_inf k representing k television channels transmitted in parallel.

Furthermore it is assumed that for each subscriber connected to the subscriber access units AE or via each subscriber connection TLN 11_nk provided for the purpose a (subscriber-individual) virtual connection starting from the relevant subscriber is set up via the decentralized module DBG1_z via the Ethernet EN through to the control unit STGZ arranged in the central module ZBG. These virtual connections vid_11_nk are also referred to as “Ethernet VLANs” and are embodied in accordance with IEEE Standards 802.1Q and 802.1D. With the aid of these virtual connections vid_11_nk each connected subscriber has at least one logically separate communication channel via the access network ACCESS. It should be pointed out that alternatively the virtual connections vid_11_nk on the subscriber side specific to the individual subscriber connections can also be terminated at the relevant subscriber connection TLN11_nk.

In accordance with the invention an additional connection vid_m individual to the communication units, virtual and designed in accordance with IEEE Standards 802.1Q and 802.1D is set up via the Ethernet EN between the control unit STGD arranged in the decentralized module DBGL_z and the control unit STGZ arranged in the central module ZBG, via which, within the framework of the method in accordance with the invention, the broadcasting information which has been requested or subscribed to simultaneously by a number of subscribers TLN11_nk connected to the decentralized module DBG1_z is transmitted in each case.

Between each subscriber TLN11_nk connected to the decentralized module DBG1_z and the IGMP instance arranged in the central module ZBG the corresponding IGMP protocol for subscriber-individual selection of broadcasting information m_inf routed to the central module ZBG—e.g. specific television channels—is implemented from the multicast data stream.

The method in accordance with the invention is explained in more detail below:

With the aid of the IGMP protocol implemented in each case at least a part of the broadcasting information m_inf routed to the central module ZBG can be selected by each subscriber TLN11_nk. To this end the subscribers TLN11_nk signal with the aid of the IGMP protocol their desire to be members of a corresponding “multicast group”. In accordance with the invention the data exchanged within the framework of the IGMP protocol (here for example IGMP Join/Leave Requests) is forwarded via the relevant decentralized module DBG1_z transparently over the Ethernet EN to the central module ZBG, but the data transmitted is read, evaluated and registered (logged) by the control unit STGD arranged in the decentralized module DBG. This “logging” of the information transmitted within the framework of the IGMP protocol is also referred to as “IGMP snooping”. The information snooped within the framework of IGMP snooping snoop-inf allows subscriber connections requesting specific broadcasting information to be assigned or the virtual connections vid_11_nk routed via these subscriber connections TLN11_nk to be assigned to the relevant multicast group. The snooped information snoop-inf is stored in a memory MEM provided in the decentralized module DBG1_z and assigned to the control unit STGD.

The IGMP Requests mentioned are transmitted via the Ethernet EN to the IGMP instance arranged in the central module ZBG and which terminates the IGMP protocol. With the aid of the information transmitted to the IGMP instance the virtual connection vid_11_nk specific to the subscriber connection via which the multicast groups or broadcasting information m_inf are requested can be determined. This information is stored as distribution information vie for example in the form of a table taub(vie) in a memory MEM on the central module ZBG.

The broadcasting information m_inf arriving within the framework of the multicast at the input ZE of the central module ZBG is checked with the aid of the distribution information vi stored in the memory MEM within the framework of a “LookUp1. Part of the check establishes which broadcasting information m-inf—i.e. in this exemplary embodiment which television channel—is to be transmitted via which virtual connection vid_11_nk to the relevant subscriber TLN11_nk connected to the decentralized module DBG1_z. If the broadcasting information m_inf arriving or a part of this broadcasting information m_inf has been requested simultaneously by a number of subscribers TLN11_nk connected to the communication unit or module DBG1_z—for example if a specific television channel (Sport) is requested by n-subscribers—in accordance with the known prior art a part of the broadcasting information arriving and representing the desired sport television channel—because the multicast protocol is terminated in the central module ZBG—would have to be replicated n times in the central module ZBG and the broadcasting information thus replicated or duplicated forwarded via the virtual connections vid_11_nk specific to the subscriber connections over the Ethernet EN to the corresponding subscribers TLN11_nk.

By contrast with this multicast solution which is to be assigned to the known prior art, in accordance with the inventive method a check is made by the control unit STGZ arranged in the central module ZBG as to whether the broadcasting information m_inf arriving or a part of said information is to be transmitted to a number of physical subscribers or subscribers TLN11_nk assigned locally to a decentralized module DBG1_z. If the check establishes that at least a part of the broadcasting information m_inf arriving at the input ZE of the central module ZBG is to be transmitted to a number of subscribers of a module, this at least one part of the broadcasting information m_inf arriving will be assigned a specific Ethernet multicast MAC address and this part inserted into an Ethernet data frame. In accordance with the invention the IP multicast address of the broadcasting information m_inf involved will be converted or “mapped” into a corresponding Ethernet multicast address. The Ethernet data frame generated in this way will however not be fed at the central module ZBG (after previous replication) into the virtual connections vid_11_nk assigned to the individual subscriber TLN11_nk, but will be transmitted via the individual virtual connection vid_m for the communication unit set up specifically for the purpose to the corresponding decentralized module DBG1_z, or to the control unit STGD arranged within it and which terminates the virtual connection vid_m. This Ethernet data frame is thus correctly replicated at logical level, but at physical level will only be transmitted once over the Ethernet EN via the virtual connection vid_m provided for it. Shifting the replication of the transferred broadcasting information which is necessary as part of the multicast in the direction of the subscriber enables transmission resources of the Ethernet EN to be saved.

With the aid of the information snoop-inf determined within the framework of the IGMP snooping and stored in the decentralized module DBG1_z an assignment of the Ethernet data frame received, i.e. a mapping or conversion of the received Ethernet multicast address to the corresponding addressed subscriber connections TLN11_nk or to all the virtual connections vid_11_nk routed via them can be undertaken. The broadcasting information to be directed to the control unit STGD via the virtual connection vid_m (which for example represents one or more specific television channels) is thus forwarded to all subscribers, by whom (by means of an IGMP Request) the relevant broadcasting information is requested.

In accordance with the invention the broadcasting information m_inf received with the aid of the Ethernet data frame in the decentralized module DBG1_z will be replicated appropriately often depending on the requirements of the subscriber and the replicated broadcasting information will be fed into the relevant virtual connection vid_11_nk specific to the subscriber. This is done by simply modifying the identification of the individual virtual connection vid_11_nk and feeding it back into the Ethernet switch EN-SW provided for the purpose in the decentralized module DBG1_z. The broadcasting information fed in this way into the corresponding virtual connection vid_11_nk will be forwarded in the usual way to the requesting subscribers.

The advantage of the method in accordance with the invention is that the replication of the broadcasting information to be transmitted to a number of local subscribers assigned to a module, i.e. the replication point, is shifted further in the direction of the subscribers and thereby the transmission resources required to cover the transmission of the broadcasting information can be used more efficiently. The replication point is shifted in this case independently of the termination of the multicast protocol which is implemented in the central module ZBG. In accordance with the invention each central module ZBG has background knowledge or information about which subscribers are members of a multicast group or have requested the same broadcasting information and are simultaneously physically assigned to a decentralized module. Advantageously the broadcasting information to be transmitted to these subscribers can be simply transmitted via a specific virtual connection, with replication being undertaken later at the decentralized module.

In accordance with a further design variant the subscribers assigned to a decentralized module DBG can be connected by means of different data transmission methods i.e. via differently designed protocol stacks or protocol levels—e.g. with or without PPP (Point to Point protocol) between the IP and Ethernet protocol level. If this type of configuration is available, in accordance with an advantageous development of the method in accordance with the invention, for each type of protocol stack implemented in a decentralized communication unit or at a decentralized module a separate virtual connection specific to the communication unit or module and protocol stack can be set up for transmitting the broadcasting information between the relevant decentralized module DBG and the central module ZBG. The snooping of information described within the framework of the IGMP data exchange both on the decentralized module side (IGMP snooping) and also on the central module side is undertaken in a suitable way, with additional, i.e., protocol stack-specific information being retained and stored both in the central and also in the decentralized module (vi, snoopinf).

1.-24. (canceled)

25. A method for transmission of a broadcasting information routed to a central communication unit to a subscriber connection assigned to a decentralized communication unit via a communication network, comprising:
providing a first virtual connection via the central communication unit to a subscriber via the communication network, the first virtual connection adapted for transmission of an information for the subscriber connection;
providing a second virtual connection between the central unit and the decentralized communication unit; and
checking if at least a portion of the broadcasting information is to be transmitted to the subscriber connection, and if the at least portion of the broadcasting information is to be transmitted, then
transmitting the at least a portion of the broadcasting information over the second virtual connection to the decentralized communication unit,
duplicating the at least a portion of the broadcasting information transmitted in the decentralized communication unit,
forwarding the duplicated information to the subscriber connection.

26. The method according to claim 25, wherein the duplicated information is inserted into the first virtual connection and is forwarded to the subscriber connection.

27. The method according to claim 2, further comprising:
detecting in the central communication unit the at least a portion of the broadcasting information to be transmitted;
assigning addressing information identifying a number of the subscriber connections to the detected information;
transmitting the detected information with the assigned addressing information via the second virtual connection to the decentralized communication unit;
duplicating the at least a portion of the broadcasting information transmitted based on the assigned addressing information; and
inserting the duplicated information into the first virtual connection.

28. The method according to claim 25, wherein a distribution information is stored in the central communication unit, the distribution information indicates the subscriber connection of the decentralized communication unit to which the relevant incoming broadcasting information is to be transmitted, the broadcasting information routed to the central communication unit checked via the stored distribution information as to whether at least a part is to be transmitted to the subscriber connections.

29. The method according to claim 27, wherein an information set is stored in the decentralized communication unit through which the addressing information assigned to the transmitted broadcasting information is assigned to the connection is selected from the group subscriber connection, first virtual connection, and combinations thereof.

30. The method according to claim 25, wherein different transmission protocols are implemented by the first virtual connection and for each transmission protocol implemented via the decentralized communication unit, the second virtual connection set up for the individual transmission protocol between the central and the decentralized communication unit.

31. The method according to claim 30, further comprising:
identifying the broadcasting information routed to the central communication to be transmitted to a number of subscriber connections implementing the same transmission protocol of the decentralized communication unit;
transmitting the identified information from the central communication unit via the second virtual connection to the decentralized communication unit;
duplicating the transmitted information in the decentralized communication unit; and
forwarding the duplicated information to the number of subscriber connections implementing the same transmission protocol.

32. The method according with claim 30, wherein the transmission protocol implemented by the subscriber connections is additionally indicated by the distribution information stored in the central communication unit.

33. The method according to claim 28, wherein a subscriber-individual selection of the at least a part of the broadcasting information is made in the central communication unit via the distribution information being updated as a function of the relevant subscriber-individual selection.

34. The method according to claim 33, wherein the subscriber-individual selection is made as part of the IGMP protocol terminated in the central communication unit and that within the framework of the IGMP protocol, the selection information is transmitted via the decentralized communication unit, the selection information is read and evaluated in the decentralized communication unit and via of the evaluation result the information set stored in the decentralized communication unit is updated.

35. The method according to claim 25, wherein the communication network is embodied as a frame-oriented or a packet-oriented communication network in accordance with IEEE Standard 802.3 and that the first virtual connections are embodied in accordance with IEEE Standards 802.1Q and 802.1D.

36. The method according to claim 25, wherein the broadcasting information routed to the central communication unit is embodied in accordance with the Internet Protocol or the TCP/IP protocol.

37. The method according to claim 36, wherein the at least part of the broadcasting information routed to the central communication unit is inserted into a Ethernet data frame having a routing and payload information, with the addressing information assigned in each case representing a component of the routing information of the Ethernet data frame.

38. The method according to claim 37, wherein the assigned addressing information represents an Ethernet multicast MAC address.

39. The method according to claim 25, wherein the broadcasting information routed to the central communication unit is transmitted via a higher-level communication network connected to the central communication unit.

40. A communication system for transmission of broadcasting information routed to a central communication unit to a subscriber connection assigned to a decentralized communication unit via a communication network, comprising:
a first virtual connection from the central communication unit via the communication network, via the decentralized communication unit to a subscriber connection unit, the first virtual connection for transmission of information for the subscriber connection;
a second virtual connection between the central and the a decentralized communication unit;
a first controller in the central communication adapted to check if at least part of the broadcasting information is to be transmitted to a number of the subscriber connections, the at least part of the broadcast information transmitted via the second virtual connection to the decentralized communication unit; and
a second controller in the decentralized communication unit through which the transmitted information is duplicated and forwarded to the number of the subscriber connections.

41. The communication system according to claim 40, wherein the second controller is adapted so that duplicated information is inserted into the first virtual connection specific to the subscriber and is forwarded to the subscriber connection.

42. The communication system according to claim 41, wherein the first controller is adapted for assigning addressing information identifying the number of subscriber connections of the at least part of the broadcasting information to be transmitted, the information to be transmitted being transmitted with the assigned address information via the second virtual connection, the second controller adapted for duplicating the at least part of the broadcasting assigned addressing information based on the assigned addressing information and adapted for inserting into the first virtual connection the duplicated information.

43. The communication system according to claim 40, wherein the subscriber connections of the decentralized communication unit are embodied such that different transmission protocols are implemented by the first virtual connection, and for each transmission protocol implemented via the decentralized communication unit the second virtual connection is specific to a transmission protocol.

44. The communication system in accordance with claim 43, wherein:
the first controller is adapted to check whether at least a part of the broadcasting information is to be transmitted to the number of subscriber connections of the decentralized communication unit which each implement the same transmission protocol, and
wherein the first controller is adapted to transmit the part of the broadcasting information for a number of subscriber connections implementing the same transmission protocol via the a second virtual connection specific to the transmission protocol to the decentralized communication unit, and
wherein the second controller is adapted to duplicated and forward the transmission of the at least one part of the broadcasting information to the subscriber connection implementing the same transmission protocol.

45. A communication device which can be arranged in a communication network,
a first virtual connection from a central communication unit via a communication network, via the decentralized communication unit to a subscriber connection unit, the first virtual connection for transmission of broadcasting information for a subscriber connection, the broadcasting information routed to the central communication unit to a subscriber connection assigned to a decentralized communication unit via the communication network;
a second virtual connection between the central and the a decentralized communication unit;
a first controller in the central communication adapted to check if at least part of the broadcasting information is to be transmitted to a number of the subscriber connections, the at least part of the broadcast information transmitted via the second virtual connection to the decentralized communication unit; and
a second controller in the decentralized communication unit through which the transmitted information is duplicated and forwarded to the number of the subscriber connections.
